(19) United States
(12) Patent Application Publication
(10) Pub. No.: US 2025/0030045 A1
(43) Pub. Date: Jan. 23, 2025

(54) SOLID ELECTROLYTE MATERIAL AND BATTERY USING SAME

(71) Applicant: Panasonic Intellectual Property Management Co., Ltd., Osaka (JP)

(72) Inventors: TAKASHI KUBO, Hyogo (JP); KAZUFUMI MIYATAKE, Osaka (JP); YOSHIAKI TANAKA, Kyoto (JP); RYUHEI KATAYAMA, Osaka (JP); AKINOBU MIYAZAKI, Osaka (JP)

(21) Appl. No.: 18/904,155

(22) Filed: Oct. 2, 2024

Related U.S. Application Data
(63) Continuation of application No. PCT/JP2023/007416, filed on Feb. 28, 2023.

(30) Foreign Application Priority Data
Apr. 12, 2022 (JP) 2022-065915

(51) Int. Cl. H01M 10/0562; C01G 35/00; C01G 35/02; H01M 4/04; H01M 10/052

(52) U.S. Cl. CPC H01M 10/0562; C01G 35/006; C01G 35/02; H01M 4/0471; H01M 10/052

(57) ABSTRACT

A solid electrolyte material of the present disclosure comprises Li, M, O, and X, wherein M is at least one selected from the group consisting of Nb and Ta, and X is at least one selected from the group consisting of F, Cl, Br, and I. The solid electrolyte material contains columnar crystals. The average of aspect ratios (L/W) of the length (L) and the width (W) of the columnar crystals is 5 or more, and the average length is 20 μm or less. A battery of the present disclosure includes a positive electrode, a negative electrode, and an electrolyte layer disposed between the positive electrode and the negative electrode. At least one selected from the group consisting of the positive electrode, the negative electrode, and the electrolyte layer contains the solid electrolyte material according to the present disclosure.

### BACKGROUND

### 1. Technical Field

The present disclosure relates to a solid electrolyte material and a battery using it.

### 2. Description of the Related Art

International Publication No. WO 2020/137153 discloses a solid electrolyte material including Li, M, O, and X. Here, M is at least one element selected from the group consisting of Nb and Ta, and X is at least one element selected from the group consisting of Cl, Br, and I.

### SUMMARY

One non-limiting and exemplary embodiment provides a solid electrolyte material that can suppress a decrease in ion conductivity due to heat.

In one general aspect, the techniques disclosed here feature a solid electrolyte material comprising Li, M, O, and X, wherein M is at least one selected from the group consisting of Nb and Ta, and X is at least one selected from the group consisting of F, Cl, Br, and I, the solid electrolyte material includes columnar crystals, and an average of aspect ratios (L/W) of the length (L) and the width (W) of the columnar crystals is 5 or more, and an average length is 20 μm or less.

The present disclosure provides a solid electrolyte material that can suppress a decrease in ion conductivity due to heat.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a flow chart showing an example of a method for manufacturing a solid electrolyte material according to a first embodiment;

FIG. 2 shows a cross-sectional view of a battery according to a second embodiment;

FIG. 3 shows a cross-sectional view of an electrode material according to the second embodiment;

FIG. 4 shows an SEM image of the solid electrolyte material of Example 1; and

FIG. 5 shows a schematic diagram of a compression molding dies that is used for evaluating the ion conductivity of a solid electrolyte material.

### DETAILED DESCRIPTIONS

### Overview of One Aspect According to the Present Disclosure

A solid electrolyte material according to a first aspect of the present disclosure comprises Li, M, O, and X, wherein
M is at least one selected from the group consisting of Nb and Ta,
X is at least one selected from the group consisting of F, Cl, Br, and I,
the solid electrolyte material includes columnar crystals, and
an average of aspect ratios (L/W) of the length (L) and the width (W) of the columnar crystals is 5 or more, and an average length is 20 μm or less.

The solid electrolyte material according to the first aspect can easily form a path for diffusion of lithium ions and, at the same time, suppresses evaporation of the constituent elements by heat. Accordingly, a decrease in ion conductivity due to heat can be suppressed. The solid electrolyte material according to the first aspect has improved ion conductivity and heat-resisting property.

In a second aspect of the present disclosure, for example, in the solid electrolyte material according to the first aspect, X may include Cl.

The solid electrolyte material according to the second aspect has improved ion conductivity and heat-resisting property.

In a third aspect of the present disclosure, for example, in the solid electrolyte material according to the first or second aspect, M may include Ta.

The solid electrolyte material according to the third aspect has an improved ion conductivity and heat-resisting property.

In a fourth aspect of the present disclosure, for example, in the solid electrolyte material according to any one of the first to third aspects, the molar ratio of Li to M may be 0.60 or more and 3.0 or less.

The solid electrolyte material according to the fourth aspect has improved ion conductivity and heat-resisting property.

In a fifth aspect of the present disclosure, for example, in the solid electrolyte material according to any one of the first to fourth aspect, the molar ratio of O to X may be 0.05 or more and 0.4 or less.

The solid electrolyte material according to the fifth aspect has more improved ion conductivity and heat-resisting property.

A battery according to a sixth aspect of the present disclosure comprises:
a positive electrode;
a negative electrode; and
an electrolyte layer arranged between the positive electrode and the negative electrode, wherein
at least one selected from the group consisting of the positive electrode, the negative electrode, and the electrolyte layer contains the solid electrolyte material according to any one of the first to fifth aspects.

The battery according to the sixth aspect can stably operate even in an environment with temperature changes and can have excellent charge and discharge characteristics. In addition, even if heat treatment at high temperature is performed in the process of manufacturing the battery, the battery can have excellent charge and discharge characteristics.

A manufacturing method according to a seventh aspect of the present disclosure is a method for manufacturing the solid electrolyte material according to any one of the first to fifth aspects, comprising:
synthesizing a compound including Li, M, O, and X; and
columnarizing the compound, wherein
M is at least one selected from the group consisting of Nb and Ta, and X is at least one selected from the group consisting of F, Cl, Br, and I,
the columnarizing includes post-annealing treatment and pulverization treatment, and
the pulverization treatment is performed after the post-annealing treatment.

The manufacturing method according to the seventh aspect can manufacture a solid electrolyte material that can suppress a decrease in ion conductivity due to heat.

Embodiments of the present disclosure will now be described with reference to the drawings. The present disclosure is not limited to the following embodiments.

### First Embodiment

The solid electrolyte material according to the first embodiment includes Li, M, O, and X. Here, M is at least one selected from the group consisting of Nb and Ta, and X is at least one selected from the group consisting of F, Cl, Br, and I. The solid electrolyte material according to the first embodiment includes columnar crystals.

The solid electrolyte material according to the first embodiment includes columnar crystals and thereby can reduce a decrease in ion conductivity due to heat. More specifically, in a solid electrolyte material including Li, M, O, and X including columnar crystals, evaporation of the constituent elements by heat is suppressed. As a result, the solid electrolyte material according to the first embodiment can also reduce the decrease in ion conductivity by heat. In addition, according to the above configuration, a path for diffusion of lithium ions is easily formed. As a result, the solid electrolyte material according to the first embodiment, for example, can have a practical ion conductivity and, for example, can have a high lithium ion conductivity and an excellent heat-resisting property, in addition to suppressing a decrease in ion conductivity due to heat. An example of the high lithium ion conductivity is 0.1 mS/cm or more at around room temperature. The room temperature is, for example, 22° C. The solid electrolyte material according to the first embodiment can have, for example, an ion conductivity of 0.1 mS/cm or more. The solid electrolyte material according to the first embodiment can also have an ion conductivity of, for example, 1.5 mS/cm or more.

In the present disclosure, the term “columnar crystal” refers to a crystal grew in one direction and means a crystal having an aspect ratio (L/W) of the length (L) and the width (W) of greater than 2. The aspect ratio is a ratio of the length (L) to the width (W) of a crystal. In the present disclosure, the length and width of a columnar crystal means the length of the long side and the length of the short side, respectively, of the columnar crystal. Here, the length of the long side is the maximum diameter of a crystal in a flat image of the crystal observed with a scanning electron microscope, and the length of the short side is the maximum value of the diameter in a direction orthogonal to the maximum diameter. The shape of the tip of the crystal is not limited, and the term “columnar crystal” includes an acicular crystal.

Whether a solid electrolyte material includes columnar crystals or not can be verified by observation with a scanning electron microscope (SEM).

The solid electrolyte material according to the first embodiment may be a powder, and the powder may include crystalline columnar particles or acicular particles.

When a large-sized battery using a solid electrolyte material is manufactured, the positive electrode, electrolyte layer, and negative electrode of the battery are required to be subjected to a heat treatment process at high temperature for densification and conjugation. The temperature in the heat treatment process is, for example, from about 200° C. to about 300° C. Even when heat treatment at about 300° C. is performed, the ion conductivity of the solid electrolyte material according to the first embodiment is less likely to be decreased or is not decreased. Thus, the solid electrolyte material according to the first embodiment has an excellent heat-resisting property.

In the solid electrolyte material according to the first embodiment, a decrease in ion conductivity is suppressed in an expected operating temperature range of the battery (e.g., a range of from −30° C. to 80° C.), a lithium ion conductivity that is sufficient for battery operation can be maintained. Accordingly, the battery using the solid electrolyte material according to the first embodiment can stably operate even in an environment with temperature changes.

The solid electrolyte material according to the first embodiment can be used for obtaining excellent charge and discharge characteristics. An example of the battery is an all-solid-state battery. The battery may be a primary battery or may be a secondary battery.

From the viewpoint of safety, the solid electrolyte material according to the first embodiment is desirably essentially sulfur-free. The phrase “the solid electrolyte material according to the first embodiment is essentially sulfur-free” means that the solid electrolyte material does not include sulfur as a constituent element, except for sulfur that is unavoidably mixed in as an impurity. In this case, the amount of sulfur that is mixed in the solid electrolyte material as an impurity is, for example, 1 mol % or less. From the viewpoint of safety, the solid electrolyte material according to the first embodiment is desirably sulfur-free. The sulfur-free solid electrolyte material does not generate hydrogen sulfide even if exposed to the atmosphere and is therefore excellent in safety.

The solid electrolyte material according to the first embodiment may consist essentially of Li, M, O, and X in order to enhance the ion conductivity and heat-resisting property of the solid electrolyte material. Here, the phrase “the solid electrolyte material according to the first embodiment consists essentially of Li, M, O, and X” means that the proportion of the sum of the amounts of Li, M, O, and X to the sum of the amounts of the all elements constituting the solid electrolyte material according to the first embodiment is 90% or more. As an example, the proportion may be 95% or more.

In order to enhance the ion conductivity and heat-resisting property of the solid electrolyte material, the solid electrolyte material according to the first embodiment may consist of Li, M, O, and X only.

In order to enhance the ion conductivity and heat-resisting property of the solid electrolyte material, in the solid electrolyte material according to the first embodiment, X may include Cl, or X may be Cl.

In order to enhance the ion conductivity and heat-resisting property of the solid electrolyte material, in the solid electrolyte material according to the first embodiment, M may include Ta, or M may be Ta.

In order to enhance the ion conductivity and heat-resisting property of the solid electrolyte material, in the solid electrolyte material according to the first embodiment, the molar ratio of Li to M (hereinafter, referred to as “Li/M molar ratio”) may be 0.60 or more and 3.0 or less. In the solid electrolyte material according to the first embodiment, the molar ratio of O to X (hereinafter, referred to as “O/X molar ratio”) may be 0.05 or more and 0.4 or less. The Li/M molar ratio may be 0.60 or more and 3.0 or less, and, at the same time, the O/X molar ratio may be 0.05 or more and 0.4 or less.

In order to enhance the ion conductivity and heat-resisting property of the solid electrolyte material, in the solid electrolyte material according to the first embodiment, the Li/M molar ratio may be 1.5 or more and 3.0 or less or may be 2.4 or more and 2.7 or less. The O/X molar ratio may be 0.27 or more and 0.4 or less or may be 0.3 or more and 0.4 or less. The Li/M molar ratio may be 1.5 or more and 3.0 or less, and, at the same time, the O/X molar ratio may be 0.27 or more and 0.4 or less. The Li/M molar ratio may be 2.4 or more and 2.7 or less, and, at the same time, the O/X molar ratio may be 0.3 or more and 0.4 or less.

In order to enhance the ion conductivity and heat-resisting property of the solid electrolyte material, in the solid electrolyte material according to the first embodiment, the Li/M molar ratio may be 2.6, and, at the same time, the O/X molar ratio may be 0.38.

In the solid electrolyte material according to the first embodiment, the average of aspect ratios (L/W) of the length (L) and the width (W) of the columnar crystals is 5 or more, and the average length of the columnar crystals is 20 μm or less. Consequently, the ion conductivity and heat-resisting property of the solid electrolyte material can be improved. The average of aspect ratios (L/W) of the length and the width of the columnar crystals may be 5 or more and 100 or less, and, at the same time, the average length of the columnar crystals may be 3 μm or more and 20 μm or less. The average of the aspect ratios and average length of the columnar crystals are calculated as the average values of the aspect ratios and lengths of ten columnar crystals having a length of 3 μm or more measured from an electron microscope image.

The shape and size of the solid electrolyte material can be measured with a scanning electron microscope (SEM) or an image analyzer.

### Manufacturing Method of Solid Electrolyte Material

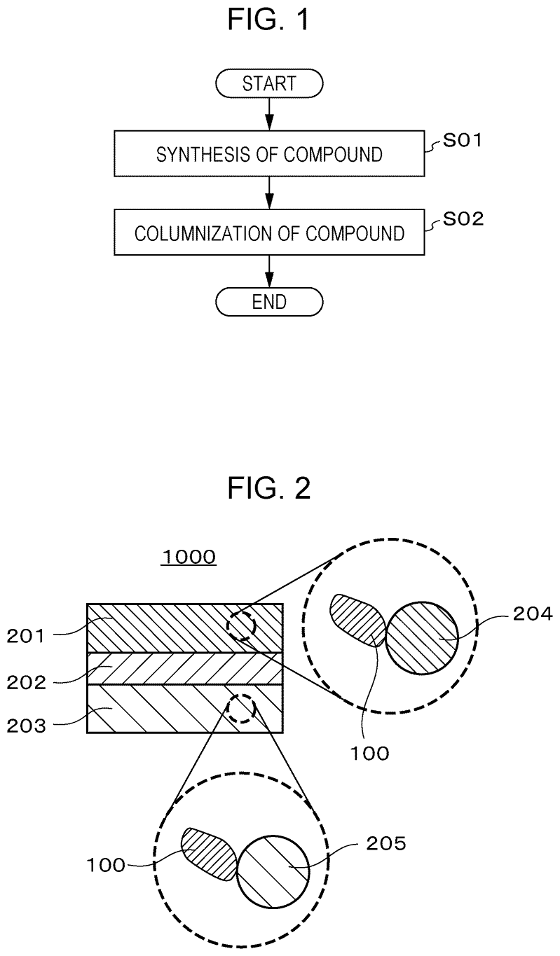

The solid electrolyte material according to the first embodiment will now be described with reference to FIG. 1. FIG. 1 is a flow chart showing an example of a method for manufacturing the solid electrolyte material according to the first embodiment.

The method for manufacturing the solid electrolyte material according to the first embodiment includes synthesizing a compound including Li, M, O, and X (S01) and columnarizing the synthesized compound (S02). Hereinafter, the step of synthesizing the compound is referred to as a synthesis step, and the step of columnarizing the synthesized compound is referred to as a columnization step. M is at least one selected from the group consisting of Nb and Ta, and X is at least one selected from the group consisting of F, Cl, Br, and I. The columnization step S02 includes post-annealing treatment and pulverization treatment, and the pulverization treatment is performed after the post-annealing treatment. The synthesis step S01 and the columnization step S02 are carried out in this order.

In the synthesis step S01, raw material powders are first provided so as to give a desired composition. Examples of the raw material powder are an oxide, a hydroxide, a halide, and an acid halide.

As an example, in a solid electrolyte material constituted of Li, Ta, O, and Cl, when the values of Li/M and O/X molar ratios at the time of mixing raw materials are set to 1.2 and 0.17, respectively, Li₂O, LiOH, and TaCl₅ are prepared at a molar ratio of Li₂O LiOH:TaCl₅=0.4:0.4:1.0.

The element types of M and X are determined by selecting the types of the raw material powders. The molar ratios of Li/M and O/X are determined by selecting the mixing ratio of the raw materials.

The raw material powders may be mixed at a molar ratio adjusted in advance such that the compositional change that may occur during the synthesis process is offset.

A reaction product is obtained by heat-treating a mixture of raw material powders. In order to suppress evaporation of raw materials by heat treatment, a mixture of raw material powders may be sealed in an airtight container made of quartz glass or borosilicate glass in vacuum or inert gas atmosphere and heat-treated. The inert gas atmosphere is, for example, an argon atmosphere or nitrogen atmosphere. Alternatively, a reaction product may be obtained by mechanochemically reacting a mixture of raw material powders with each other in a mixing apparatus such as a planetary ball mill. That is, raw materials may be mixed and reacted by a method of mechanochemical milling.

A solid electrolyte material consisting of Li, M, O, and X is obtained by these methods.

Part of M and part of X are evaporated by heat-treating the solid electrolyte material. As a result of this, the value of the Li/M molar ratio of the resulting solid electrolyte material becomes larger than the value calculated from the molar ratios of the provided raw material powders.

In the columnization step S02, the solid electrolyte material produced in the synthesis step S01 is columnarized.

In the columnization step S02, post-annealing treatment and pulverization treatment are performed in this order.

The post-annealing treatment may be, for example, heat treatment for 30 minutes or more and 240 minutes or less. The heat treatment temperature is, for example, 150° C. or more and 300° C. or less.

The pulverization treatment is, for example, wet pulverization treatment.

In the wet pulverization treatment, an organic solvent and a solid electrolyte material are first mixed. The method for mixing is not particularly limited. The blending ratio of the organic solvent and the solid electrolyte material may be appropriately selected.

Hereinafter, a solution consisting of the organic solvent and the solid electrolyte material is referred to as “solid electrolyte composition”.

The wet pulverization treatment uses a pulverization medium.

The shape of the pulverization medium is not limited. Examples of the shape of the pulverization medium are spherical and barrel-type shapes.

The size of the pulverization medium largely depends on the size of the solid electrolyte material after columnization. For example, it is desirable to use a spherical pulverization medium having a diameter of 1.0 mm or less.

The wet pulverization treatment is performed by, for example, roll milling, pot milling, or planetary ball milling which performs pulverization by rotating a container containing an organic solvent, a solid electrolyte material, and a pulverization medium.

The pulverization treatment may be bead milling which performs pulverization in a pulverization chamber containing a pulverization medium and equipped with a rotor by rotating the rotor at a high speed and allowing a solution obtained by mixing an organic solvent and a solid electrolyte to pass therethrough.

Separation of the solid electrolyte composition and the pulverization medium after pulverization uses, for example, a sieve. The conditions of pulverization may be appropriately set according to the respective apparatuses.

After pulverization, the organic solvent is removed from the solid electrolyte composition.

The organic solvent may be removed by reduced-pressure drying or vacuum drying. The reduced-pressure drying refers to removing the organic solvent from the solid electrolyte composition in an atmosphere with a pressure lower than the atmospheric pressure. The atmosphere with a pressure lower than the atmospheric pressure may be, for example, −0.01 MPa or less as the gauge pressure. The solid electrolyte composition may be heated to 50° C. or more and 250° C. or less during the reduced-pressure drying.

The vacuum drying refers to removing the organic solvent from the solid electrolyte composition, for example, below the vapor pressure at a temperature lower than the boiling point of the organic solvent by 20° C.

The organic solvent may be removed by heating the solid electrolyte composition in an inert gas flow environment. Examples of the inert gas are nitrogen and argon. The temperature of heating is, for example, 50° C. or more and 250° C. or less.

As in above, the solid electrolyte material according to the first embodiment is obtained.

The composition of the solid electrolyte material can be determined by, for example, inductively coupled plasma (ICP) emission spectral analysis, ion chromatography, or an inert gas fusion-infrared absorption method. For example, the compositions of Li and M can be determined by ICP emission spectral analysis, the composition of X can be determined by ion chromatography, and O can be measured by an inert gas fusion-infrared absorption method.

### Second Embodiment

A second embodiment will now be described. The matters described in the first embodiment will be omitted as appropriate.

The battery according to the second embodiment includes a positive electrode, an electrolyte layer, and a negative electrode. The electrolyte layer is arranged between the positive electrode and the negative electrode. At least one selected from the group consisting of the positive electrode, the electrolyte layer, and the negative electrode contains the solid electrolyte material according to the first embodiment.

The battery according to the second embodiment contains the solid electrolyte material according to the first embodiment and thereby can maintain excellent charge and discharge characteristics, even if the battery is exposed to high temperature. The battery is, for example, heat-treated at high temperature at the time of manufacturing.

FIG. 2 shows a cross-sectional view of a battery 1000 according to the second embodiment.

The battery 1000 includes a positive electrode 201, an electrolyte layer 202, and a negative electrode 203. The electrolyte layer 202 is arranged between the positive electrode 201 and the negative electrode 203.

The positive electrode 201 contains a positive electrode active material particle 204 and a solid electrolyte particle 100.

The electrolyte layer 202 contains an electrolyte material. The electrolyte material is, for example, a solid electrolyte material.

The negative electrode 203 contains a negative electrode active material particle 205 and a solid electrolyte particle 100.

The solid electrolyte particle 100 is a particle including the solid electrolyte material according to the first embodiment. The solid electrolyte particle 100 may be a particle including the solid electrolyte material according to the first embodiment as a main component. The particle including the solid electrolyte material according to the first embodiment as a main component means a particle in which the component included at the highest molar ratio is the solid electrolyte material according to the first embodiment. The solid electrolyte particle 100 may be a particle consisting of the solid electrolyte material according to the first embodiment.

The positive electrode 201 contains a material that can occlude and release metal ions such as lithium ions. The positive electrode 201 contains, for example, a positive electrode active material (e.g., the positive electrode active material particle 204).

Examples of the positive electrode active material are a lithium-containing transition metal oxide, a transition metal fluoride, a polyanionic material, a fluorinated polyanionic material, a transition metal sulfide, a transition metal oxysulfide, and a transition metal oxynitride. Examples of the lithium-containing transition metal oxide are Li(Ni,Co,Al)O₂, Li(Ni,Co,Mn)O₂, and LiCoO₂.

In the present disclosure, “(A,B,C)” means “at least one selected from the group consisting of A, B, and C”.

From the viewpoint of the cost and safety of a battery, lithium phosphate may be used as the positive electrode active material.

When the positive electrode 201 contains the solid electrolyte material according to the first embodiment and X includes I (i.e., iodine), iron lithium phosphate may be used as the positive electrode active material. The solid electrolyte material according to the first embodiment including I is easily oxidized. The oxidation reaction of the solid electrolyte material is suppressed by using iron lithium phosphate as the positive electrode active material. That is, formation of an oxide layer having a low lithium ion conductivity is suppressed. As a result, the battery has a high charge and discharge efficiency.

The positive electrode 201 may also contain a transition metal oxyfluoride as the positive electrode active material in addition to the solid electrolyte material according to the first embodiment. Even if the solid electrolyte material according to the first embodiment is fluorinated by a transition metal fluoride, a resistive layer is unlikely to be formed. As a result, the battery has a high charge and discharge efficiency.

The transition metal oxyfluoride contains oxygen and fluorine. As an example, the transition metal oxyfluoride may be a compound represented by a composition formula: LiₚMe_{q}OₘFₙ. Here, Me is at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, and mathematical expressions: 0.5≤p≤1.5, 0.5≤q≤1.0, 1≤m≤2, and 0<n≤1 are satisfied. An example of such transition metal oxyfluoride is Li_{1.05}(Ni_{0.35}Co_{0.35}Mn_{0.3})_{0.95}O_{1.9}F_{0.1}.

The positive electrode active material particle 204 may have a median diameter of 0.1 μm or more and 100 μm or less. When the positive electrode active material particle 204 has a median diameter of 0.1 μm or more, the positive electrode active material particle 204 and the solid electrolyte particle 100 can be well dispersed in the positive electrode 201. Consequently, the charge and discharge characteristics of a battery are improved. When the positive electrode active material particle 204 has a median diameter of 100 μm or less, the lithium diffusion speed in the positive electrode active material particle 204 is improved. Consequently, the battery can operate at a high output.

The positive electrode active material particle 204 may have a median diameter larger than that of the solid electrolyte particle 100. Consequently, the positive electrode active material particle 204 and the solid electrolyte particle 100 can be well dispersed in the positive electrode 201.

In order to improve the energy density and output of the battery, the ratio of the volume of the positive electrode active material particle 204 to the sum of the volume of the positive electrode active material particle 204 and the volume of the solid electrolyte particle 100 in the positive electrode 201 may be 0.30 or more and 0.95 or less.

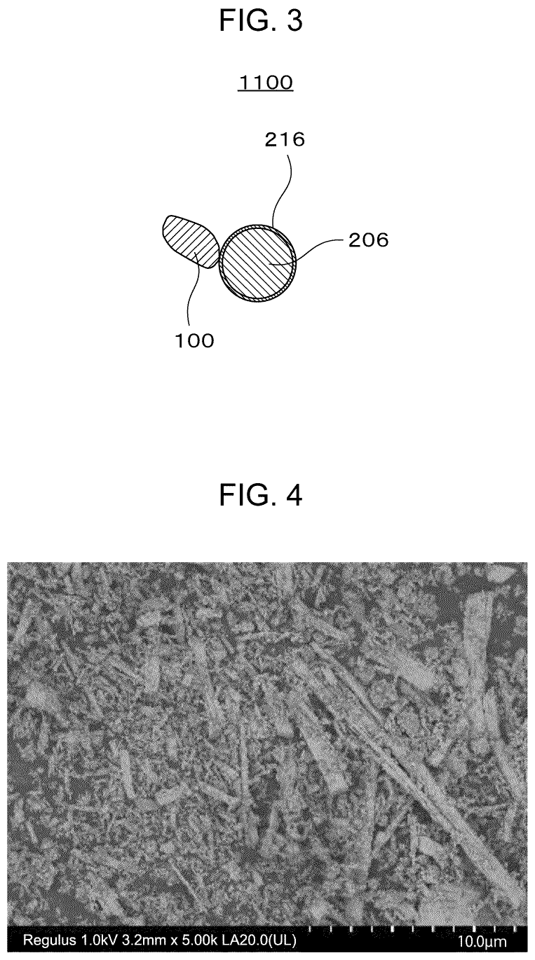

FIG. 3 shows a cross-sectional view of an electrode material 1100 according to the second embodiment. The electrode material 1100 is included in, for example, the positive electrode 201. In order to prevent the solid electrolyte particle 100 from reacting with the positive electrode active material (i.e., the electrode active material particle 206), a covering layer 216 may be formed on the surface of the electrode active material particle 206. Consequently, an increase in the reaction overvoltage of the battery can be suppressed. Examples of the covering material included in the covering layer 216 are a sulfide solid electrolyte, an oxide solid electrolyte, and a halide solid electrolyte.

When the solid electrolyte particle 100 is a sulfide solid electrolyte, the covering material may be the solid electrolyte material according to the first embodiment, and X may be at least one selected from the group consisting of Cl and Br. Such solid electrolyte material according to the first embodiment is less likely to be oxidized compared to the sulfide solid electrolyte. As a result, an increase in the reaction overvoltage of the battery can be suppressed.

When the solid electrolyte particle 100 is the solid electrolyte material according to the first embodiment and X includes I, the covering material may be the solid electrolyte material according to the first embodiment, and X may be at least one selected from the group consisting of Cl and Br. The solid electrolyte material according to the first embodiment not including I is less likely to be oxidized compared to the solid electrolyte material according to the first embodiment including I. As a result, the battery has a high charge and discharge efficiency.

When the solid electrolyte particle 100 is the solid electrolyte material according to the first embodiment and X includes I, the covering material may include an oxide solid electrolyte. The oxide solid electrolyte may be lithium niobate, which has excellent stability even at a high potential. Consequently, the battery has a high charge and discharge efficiency.

The positive electrode 201 may be composed of a first positive electrode layer containing a first positive electrode active material and a second positive electrode layer containing a second positive electrode active material. Here, the second positive electrode layer is arranged between the first positive electrode layer and the electrolyte layer 202, the first positive electrode layer and the second positive electrode layer contain the solid electrolyte material according to the first embodiment including I, and the covering layer 216 is formed on the surface of the second positive electrode active material. According to the above configuration, the solid electrolyte material according to the first embodiment included in the electrolyte layer 202 can be suppressed from being oxidized by the second positive electrode active material. As a result, the battery has a high charging capacity.

Examples of the covering material included in the covering layer 216 are a sulfide solid electrolyte, an oxide solid electrolyte, a polymeric solid electrolyte, and a halide solid electrolyte. However, when the covering material is a halide solid electrolyte, I is not included as the halogen element. The first positive electrode active material may be a material that is the same as the second positive electrode active material or a material that is different from the second positive electrode active material.

In order to improve the energy density and output of the battery, the positive electrode 201 may have a thickness of 10 μm or more and 500 μm or less.

The electrolyte layer 202 contains an electrolyte material. The electrolyte material is, for example, a solid electrolyte material. The electrolyte layer 202 may be a solid electrolyte layer. The electrolyte layer 202 may contain the solid electrolyte material according to the first embodiment. The electrolyte layer 202 may consist of only the solid electrolyte material according to the first embodiment.

The electrolyte layer 202 may consist of only a solid electrolyte material that is different from the solid electrolyte material according to the first embodiment. Examples of the solid electrolyte material that is different from the solid electrolyte material according to the first embodiment are Li₂MgX′₄, Li₂FeX′₄, Li(Al,Ga,In)X′₄, Li₃(Al,Ga,In)X′₆, and LiI. Here, X′ is at least one selected from the group consisting of F, Cl, Br, and I.

Hereinafter, the solid electrolyte material according to the first embodiment is referred to as first solid electrolyte material, and the solid electrolyte material that is different from the solid electrolyte material according to the first embodiment is referred to as second solid electrolyte material.

The electrolyte layer 202 may contain a second solid electrolyte material, in addition to a first solid electrolyte material. The first solid electrolyte material and the second solid electrolyte material may be uniformly dispersed. A layer consisting of the first solid electrolyte material and a layer consisting of the second solid electrolyte material may be stacked along the stacking direction of the battery 1000.

The electrolyte layer 202 may have a thickness of 1 μm or more and 100 μm or less. When the electrolyte layer 202 has a thickness of 1 μm or more, the positive electrode 201 and the negative electrode 203 are less likely to short circuit. When the electrolyte layer 202 has a thickness of 100 μm or less, the battery can operate at a high output.

Another electrolyte layer may be further provided between the electrolyte layer 202 and the negative electrode 203. For example, when the electrolyte layer 202 includes the first solid electrolyte material, in order to more stably maintain the high ion conductivity of the first solid electrolyte material, an electrolyte layer constituted of another solid electrolyte material that is electrochemically stable than the first solid electrolyte material may be further provided between the electrolyte layer 202 and the negative electrode 203.

The negative electrode 203 contains a material that can occlude and release metal ions (e.g., lithium ions). The negative electrode 203 contains, for example, a negative electrode active material (e.g., the negative electrode active material particle 205).

Examples of the negative electrode active material are a metal material, a carbon material, an oxide, a nitride, a tin compound, and a silicon compound. The metal material may be a single metal or may be an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material are silicon (i.e., Si), tin (i.e., Sn), a silicon compound, and a tin compound.

The negative electrode active material may be selected based on the reduction resistance of the solid electrolyte material included in the negative electrode 203. When the negative electrode 203 contains the first solid electrolyte material, a material that can occlude and release lithium ions at 0.27 V or more with respect to lithium may be used as the negative electrode active material. When the negative electrode active material is such a material, it is possible to suppress the first solid electrolyte material included in the negative electrode 203 from being reduced. As a result, the battery has a high charge and discharge efficiency. Examples of the material are a titanium oxide, indium metal, and a lithium alloy. Examples of the titanium oxide are Li₄Ti₅O₁₂, LiTi₂O₄, and TiO₂.

The negative electrode active material particle 205 may have a median diameter of 0.1 μm or more and 100 μm or less. When the negative electrode active material particle 205 has a median diameter of 0.1 μm or more, the negative electrode active material particle 205 and the solid electrolyte particle 100 can be well dispersed in the negative electrode 203. Consequently, the charge and discharge characteristics of the battery are improved. When the negative electrode active material particle 205 has a median diameter of 100 μm or less, the lithium diffusion speed in the negative electrode active material particle 205 is improved. Consequently, the battery can operate at a high output.

The negative electrode active material particle 205 may have a median diameter larger than that of the solid electrolyte particle 100. Consequently, the negative electrode active material particle 205 and the solid electrolyte particle 100 can be well dispersed in the negative electrode 203.

In order to improve the energy density and output of the battery, the ratio of the volume of the negative electrode active material particle 205 to the sum of the volume of the negative electrode active material particle 205 and the volume of the solid electrolyte particle 100 in the negative electrode 203 may be 0.30 or more and 0.95 or less.

The electrode material 1100 shown in FIG. 3 may be contained in the negative electrode 203. In order to prevent the solid electrolyte particle 100 from reacting with the negative electrode active material (i.e., the electrode active material particle 206), a covering layer 216 may be formed on the surface of the electrode active material particle 206. Consequently, the battery has a high charge and discharge efficiency. Examples of the covering material included in the covering layer 216 are a sulfide solid electrolyte, an oxide solid electrolyte, a polymeric solid electrolyte, and a halide solid electrolyte.

When the solid electrolyte particle 100 is a first solid electrolyte material, the covering material may be a sulfide solid electrolyte, an oxide solid electrolyte, or a polymeric solid electrolyte. An example of the sulfide solid electrolyte is Li₂S—P₂S₅. An example of the oxide solid electrolyte is trilithium phosphate. Examples of the polymeric solid electrolyte are polyethylene oxide and a conjugated compound of a lithium salt. An example of the polymeric solid electrolyte is lithium bis(trifluoromethanesulfonyl)imide.

In order to improve the energy density and output of the battery, the negative electrode 203 may have a thickness of 10 μm or more and 500 μm or less.

At least one selected from the group consisting of the positive electrode 201, the electrolyte layer 202, and the negative electrode 203 may contain a second solid electrolyte material for the purpose of enhancing the ion conductivity. Examples of the second solid electrolyte material are a sulfide solid electrolyte, an oxide solid electrolyte, a halide solid electrolyte, and an organic polymeric solid electrolyte.

In the present disclosure, the term “sulfide solid electrolyte” means a solid electrolyte containing sulfur. The term “oxide solid electrolyte” means a solid electrolyte containing oxygen. The oxide solid electrolyte may contain an anion (excluding a sulfur anion and a halogen anion) in addition to oxygen. The term “halide solid electrolyte” means a solid electrolyte containing a halogen element and not containing sulfur. The halide solid electrolyte may contain oxygen in addition to a halogen element.

Examples of the sulfide solid electrolyte are Li₂S—P₂S₅, Li₂S—SiS₂, Li₂S—B₂S₃, Li₂S—GeS₂, Li_{3.25} Ge_{0.25}P_{0.75}S₄, and Li₁₀GeP₂Si₂.

Examples of the oxide solid electrolyte are:
(i) an NASICON-type solid electrolyte, such as LiTi₂(PO₄)₃ or an element substitute thereof;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or an element substitute thereof;
(iv) a garnet-type solid electrolyte, such as Li₇La₃Zr₂O₁₂ or an element substitute thereof; and
(v) Li₃PO₄ or an N-substitute thereof.

Examples of the halide solid electrolyte are compounds represented by LiₐMe′_{b}Y_{c}Z₆. Here, mathematical expressions: a+mb+3c=6 and c>0 are satisfied. Me′ is at least one selected from the group consisting of metal elements other than Li and Y and metalloid elements. Z is at least one selected from the group consisting of F, Cl, Br, and I. The value of m represents the valence of Me′.

The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded).

In order to enhance the ion conductivity of the halide solid electrolyte, Me′ may be at least one selected from the group consisting of Mg, Ca, Sr, Ba, Zn, Sc, Al, Ga, Bi, Zr, Hf, Ti, Sn, Ta, and Nb.

Examples of the halide solid electrolyte are Li₃YCl₆ and Li₃YBr₆.

When the electrolyte layer 202 contains the first solid electrolyte material, the negative electrode 203 may contain a sulfide solid electrolyte. Consequently, the sulfide solid electrolyte, which is electrochemically stable against the negative electrode active material, suppresses the first solid electrolyte material and the negative electrode active material from becoming in contact with each other. As a result, the battery has low internal resistance.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and therefore has a higher ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent. Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, in a range of 0.5 mol/L or more and 2 mol/L or less.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium or tetraalkylphosphonium;
(ii) an aliphatic cyclic ammonium, such as a pyrrolidinium, a morpholinium, an imidazolinium, a tetrahydropyrimidinium, a piperazinium, or a piperidinium; and
(iii) a nitrogen-containing heterocyclic aromatic cation, such as a pyridinium or an imidazolium.

Examples of the anion included in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer may also be used as the binder. Examples of the binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above materials may be used.

At least one selected from the group consisting of the positive electrode 201 and the negative electrode 203 may contain a conductive assistant for the purpose of enhancing the electron conductivity.

Examples of the conductive assistant are:
(i) graphite, such as natural graphite or artificial graphite;
(ii) carbon black, such as acetylene black or Ketjen black;
(iii) conductive fibers, such as carbon fibers or metal fibers;
(iv) carbon fluoride;
(v) metal powders, such as aluminum;
(vi) a conductive whisker, such as zinc oxide or potassium titanate;
(vii) a conductive metal oxide, such as titanium oxide; and
(viii) a conductive polymeric compound, such as polyaniline, polypyrrole, or polythiophene.

In order to reduce the cost, the conductive assistant of the above (i) or (ii) may be used.

Examples of the shape of the battery according to the second embodiment are coin type, cylindrical type, square type, sheet type, button type, flat type, and stacked type.

The battery according to the second embodiment may be manufactured by, for example, providing a material for forming a positive electrode, a material for forming an electrolyte layer, and a material for forming a negative electrode and producing a stack in which a positive electrode, an electrolyte layer, and a negative electrode are arranged in this order by a known method.

### EXAMPLES

The present disclosure will now be described in more detail with reference to Examples.

### Example 1

### Production of Solid Electrolyte Material

### Synthesis Step

Li₂O, LiOH, and TaCl₅ were provided at a molar ratio of Li₂O:LiOH:TaCl₅=0.4:0.4:1.0 in a dry argon atmosphere having a dew point of −60° C. or less (hereinafter, simply referred to as “dry argon atmosphere”). These raw materials were pulverized and mixed in an agate mortar. The obtained mixture was placed in a quartz glass container filled with argon gas and was heat-treated at 350° C. for 3 hours. The resulting heat-treated product was pulverized in an agate mortar.

### Columnization Step

The pulverized heat-treated product was placed in an aluminum crucible and was heat-treated at 260° C. for 2 hours to perform post-annealing treatment. Consequently, a compound consisting of Ta and Cl was volatilized. Thus, a solid electrolyte material consisting of Li, Ta, O, and Cl (hereinafter, referred to as “LTOC”) was obtained.

Subsequently, pulverization treatment was performed. First, LTOC (4 g) and p-chlorotoluene (16 g) were put in a pot for planetary ball mill pulverization and were stirred with a spatula to prepare a solid electrolyte composition.

A zirconia pulverization medium (25 g) was put in the pot for planetary ball mill pulverization. The pulverization medium was spherical and had a diameter of 0.5 mm. Pulverization with a planetary ball mill (manufactured by Fritsch, PULVERISETTE 7) was performed at 300 rpm for 60 minutes. Subsequently, the pulverization medium and the solid electrolyte composition were separated with a sieve with an aperture of 212 m.

The solid electrolyte composition was placed in an air-tight glass beaker, and p-chlorotoluene was removed over a period of 2 hours by flowing nitrogen at 10 L/min and heating up to 200° C.

As a result of the above, a solid electrolyte material of Example 1 was obtained.

### Shape Observation of Solid Electrolyte Material

The shape and size of the solid electrolyte material of Example 1 were measured with a scanning electron microscope (SEM). As the SEM, Regulus 8230 manufactured by Hitachi High-Tech Corporation was used. The observation magnification was set to 5000 times. FIG. 4 shows an SEM image of the solid electrolyte material of Example 1.

The solid electrolyte material of Example 1 included columnar crystals. The average of aspect ratios (L/W) of the length (L) and the width (W) of the columnar crystals was 5 or more, and the average length was 20 μm or less. The average length and the average of aspect ratios were calculated as average values of ten columnar crystals having a length of 3 μm or more measured from an SEM image.

### Composition Analysis of Solid Electrolyte Material

The Li and M contents of the solid electrolyte material were measured by high-frequency inductively coupled plasma emission spectral analysis using a high-frequency inductively coupled plasma emission spectral analyzer (manufactured by ThermoFisher Scientific, iCAP 7400). The Cl content was measured by ion chromatography using an ion chromatographic apparatus (manufactured by Dionex, ICS-2000). The O content was measured by an inert gas fusion-infrared absorption method using an oxygen analyzer (manufactured by HORIBA, Ltd., EMGA-930). The Li/M and O/X molar ratios were calculated from the measurement results. The Li/M molar ratio of the solid electrolyte material of Example 1 was 2.6, and the O/X molar ratio was 0.38.

### Evaluation of Ion Conductivity

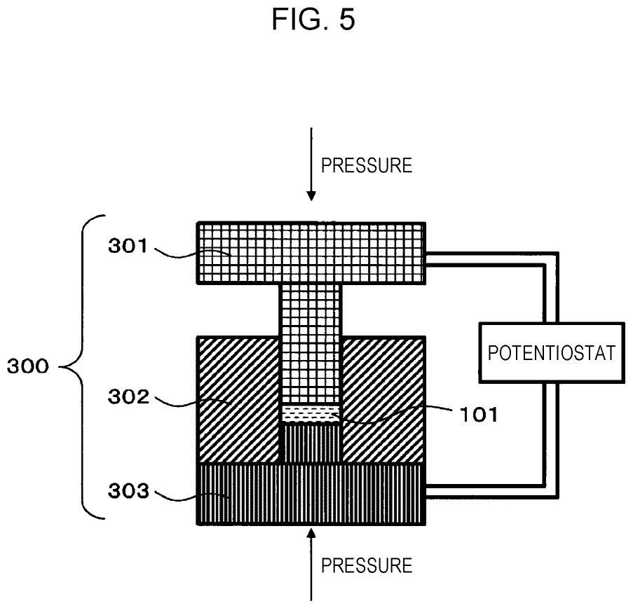

FIG. 5 shows a schematic diagram of a compression molding dies 300 that is used for evaluating the ion conductivity of a solid electrolyte material.

The compression molding dies 300 included a punch upper part 301, a die 302, and a punch lower part 303. The die 302 was formed from insulating polycarbonate. The punch upper part 301 and the punch lower part 303 were both formed from electron-conductive stainless steel.

The ion conductivity of the solid electrolyte material of Example 1 was measured using the compression molding dies 300 shown in FIG. 5 by the following method.

A powder of the solid electrolyte material of Example 1 (i.e., the powder 101 of the solid electrolyte material in FIG. 5) was loaded inside the compression molding dies 300 in a dry atmosphere. A pressure of 300 MPa was applied to the solid electrolyte material of Example 1 inside the compression molding dies 300 using the punch upper part 301.

While applying the pressure to the evaluation cell, the punch upper part 301 and the punch lower part 303 were connected to a potentiostat (Princeton Applied Research, VersaSTAT4) equipped with a frequency response analyzer. The punch upper part 301 was connected to the working electrode and the terminal for potential measurement. The punch lower part 303 was connected to the counter electrode and the reference electrode. The ion conductivity of the solid electrolyte material of Example 1 was measured by an electrochemical impedance measurement method at room temperature. As a result, the ion conductivity measured at 22° C. was 3.7 mS/cm.

### Evaluation of Heat-Resisting Property

In order to evaluate the heat-resisting property of a solid electrolyte material, the solid electrolyte material of Example 1 was heat-treated in a dry argon atmosphere at 300° C. for 3 hours. Subsequently, the ion conductivity of the solid electrolyte material of Example 1 was measured at room temperature.

The ion conductivity was measured by the same method as that described in the above paragraph “Evaluation of ion conductivity”. As a result, the ion conductivity of the solid electrolyte material of Example 1 measured at 22° C. after the heat treatment was 1.7 mS/cm.

Accordingly, the rate of change in the ion conductivity of the solid electrolyte material by heat treatment was −54%. The rate of change in the ion conductivity is calculated by [(ion conductivity after heat treatment)−(ion conductivity before heat treatment)]/(ion conductivity before heat treatment)×100.

### Reference Example 1

### Production of Solid Electrolyte Material

A solid electrolyte material of Reference Example 1 was obtained as in Example 1 except that the post-annealing treatment was carried out after pulverization treatment. That is, a heat-treated product obtained by the same synthesis step as that in Example 1 was subjected to wet pulverization treatment with a planetary ball mill. Subsequently, the organic solvent was removed, and the resulting pulverization treatment product was placed in an aluminum crucible and was heat-treated at 260° C. for 2 hours to obtain a solid electrolyte material of Reference Example 1.

### Shape Observation of Solid Electrolyte Material

The solid electrolyte material of Reference Example 1 was observed with an SEM as in Example 1. In the solid electrolyte material of Reference Example 1, no columnar crystal was observed.

### Composition Analysis of Solid Electrolyte Material

The Li, M, Cl, and O contents of the solid electrolyte material of Reference Example 1 were measured as in Example 1. The Li/M molar ratio was calculated from the measurement results. The Li/M molar ratio of the solid electrolyte material of Reference Example 1 was 1.4, and the O/X molar ratio was 0.26.

### Evaluation of Ion Conductivity

The ion conductivity of the solid electrolyte material of Reference Example 1 was measured as in Example 1. As a result, the ion conductivity measured at 22° C. was 6.6 mS/cm.

### Evaluation of Heat-Resisting Property

The ion conductivity after heat treatment of the solid electrolyte material of Reference Example 1 was measured as in Example 1. As a result, the ion conductivity of the solid electrolyte material of Reference Example 1 measured at 22° C. after heat treatment was 1.2 mS/cm.

Accordingly, the rate of change in the ion conductivity of the solid electrolyte material by heat treatment was −82%.

TABLE 1

| | | | | | Average | | | |
|---|---|---|---|---|---|---|---|---|
| | | | | Average of | length of | Ion | Ion | |
| | | Li/M | O/X | aspect ratio | columnar | conductivity | conductivity | Rate of |
| | Constituent | molar | molar | of crystal | crystal | (before heat | (after heat | change in ion |
| | element | ratio | ratio | (L/W) | (L) | treatment) | treatment) | conductivity |
| Example 1 | Li, Ta, O, Cl | 2.6 | 0.38 | greater than | less than 20 | 3.7 mS/cm | 1.7 mS/cm | −54% |
| | | | | 5 | μm | | | |
| Reference | Li, Ta, O, Cl | 1.4 | 0.26 | — | — | 6.6 mS/cm | 1.2 mS/cm | −82% |
| Example 1 | | | | | | | | |

### Consideration

As shown in Table 1, in the solid electrolyte material of Example 1, a decrease in ion conductivity by heat treatment was suppressed compared to the solid electrolyte material of Reference Example 1.

Ta and Nb are both transition metal elements in Group 5. Accordingly, even if part or the whole of Ta is substituted with Nb, the decrease in ion conductivity can be suppressed at the same level as that in Example. Similarly, even if part or the whole of Cl, which is a halogen element, is substituted with at least one selected from the group consisting of F, Br, and I, the decrease in ion conductivity can be suppressed at the same level as that in Example.

As described above, the solid electrolyte material of the present disclosure has a practical ion conductivity and can reduce a decrease in ion conductivity due to heat. Accordingly, the solid electrolyte material of the present disclosure is suitable for providing a battery having excellent charge and discharge characteristics.

The solid electrolyte material of the present disclosure is utilized in, for example, an all-solid-state lithium ion secondary battery.

What is claimed is:

1. A solid electrolyte material comprising Li, M, O, and X, wherein
M is at least one selected from the group consisting of Nb and Ta,
X is at least one selected from the group consisting of F, Cl, Br, and I,
the solid electrolyte material includes columnar crystals, and
an average of aspect ratios (L/W) of the length (L) and the width (W) of the columnar crystals is 5 or more, and an average length is 20 μm or less.

2. The solid electrolyte material according to claim 1, wherein
X includes Cl.

3. The solid electrolyte material according to claim 1, wherein
M includes Ta.

4. The solid electrolyte material according to claim 1, wherein
a molar ratio of Li to M is 0.60 or more and 3.0 or less.

5. The solid electrolyte material according to claim 1, wherein
a molar ratio of O to X is 0.05 or more and 0.4 or less.

6. A battery comprising:
a positive electrode;
a negative electrode; and
an electrolyte layer arranged between the positive electrode and the negative electrode, wherein
at least one selected from the group consisting of the positive electrode, the negative electrode, and the electrolyte layer contains the solid electrolyte material according to claim 1.

7. A method for manufacturing the solid electrolyte material according to claim 1, comprising:
synthesizing a compound including Li, M, O, and X, and
columnarizing the compound, wherein
M is at least one selected from the group consisting of Nb and Ta, and X is at least one selected from the group consisting of F, Cl, Br, and I,
the columnarizing includes post-annealing treatment and pulverization treatment, and
the pulverization treatment is performed after the post-annealing treatment.
